(19) United States
(12) Patent Application Publication
(10) Pub. No.: US 2026/0108909 A1
(43) Pub. Date: Apr. 23, 2026

(54) PLANARIZATION METHOD, PLANARIZATION SYSTEM, AND ARTICLE MANUFACTURING METHOD

(71) Applicant: CANON KABUSHIKI KAISHA, Tokyo (JP)

(72) Inventors: KAZUKI ARAI, Tochigi (JP); SHINICHI OTA, Tochigi (JP)

(21) Appl. No.: 19/356,823

(22) Filed: Oct. 13, 2025

(30) Foreign Application Priority Data
Oct. 17, 2024 (JP) 2024-181942

(51) Int. Cl. B05D 1/00; B05D 1/18; B05D 3/00

(52) U.S. Cl. CPC B05D 1/005; B05D 1/18; B05D 3/007

(57) ABSTRACT

In a planarization method using a planarization system including a plurality of processing apparatuses, the planarization system is configured to be able to perform, using the plurality of processing apparatuses, at least two steps of forming a first planarizing film by bringing a superstrate into contact with a curable composition placed on a first substrate, and spin coating a liquid film of a curable composition on a second substrate using a spin coat method. The planarization method includes performing any one of the at least two steps to perform planarization of the first substrate or the second substrate.

### BACKGROUND

### Field of the Technology

The present disclosure relates to a planarization method, a planarization system, and an article manufacturing method.

### Description of the Related Art

There is known an imprinting method of molding an imprint material on a substrate using a die as a method of manufacturing articles, such as semiconductor devices and MEMS. An imprint technology is a microfabrication technology for forming a pattern of a cured material that has a relief pattern transferred from a die by bringing the imprint material supplied on a substrate into contact with the die and providing curing energy to the imprint material.

A technology for planarizing the surface of a substrate using an imprint technology has also been suggested (see PCT Japanese Translation Patent Publication No. 2011-529626). Generally, there has been a technology to planarize the surface level differences of a substrate by forming a coating film on the substrate using an existing coating applicator (spin coater); however, such a technology is insufficient for planarizing the surface level differences of the substrate at the nanoscale. On the other hand, the technology described in PCT Japanese Translation Patent Publication No. 2011-529626 can improve the planarization accuracy by supplying a polymerizable material based on the level differences of the substrate and curing the supplied polymerizable material in a state where a template having a flat surface is brought into contact with the polymerizable material.

In the planarization suggested in PCT Japanese Translation Patent Publication No. 2011-529626, the substrate is planarized through a supply step, a contact step, a curing step, and a separation step. A planarization apparatus differs from an imprint apparatus in that a flat member having no pattern (which is referred to as “superstrate”) is brought into contact with a composition supplied over the entire substrate surface and the composition is cured in that state at a time.

A curing time of the composition supplied over the entire substrate surface in the planarization apparatus is longer than that of the imprint apparatus. The planarization apparatus uses a large amount of curing energy, and the adhesion force during the contact and separation of the planarization member and the composition supplied over the entire substrate surface is also high, on the order of hundreds of newtons. Therefore, the above contact step, curing step, and separation step each may take several tens of seconds, with the result that planarization takes time per substrate after the supply step of a composition. The throughput of the planarization apparatus to at most several tens of substrates per hour is a limit to simply sequentially process the four steps of the planarization. To increase the productivity of the planarization apparatus, the processing time of each step is desired to be minimized to the utmost or clustering of the planarization apparatuses for parallel processing of multiple substrates is desired to be implemented.

Japanese Patent Laid-Open No. 2016-149576 describes a processing apparatus in which a plurality of coating treatment sections for applying organic material on a substrate, a plurality of heat treatment sections for heat-treating a substrate, and the like, are disposed and clustered.

If a high level of flatness is requested, it is possible to achieve a further higher flatness by repeating the above-described planarization process twice.

Depending on devices to be manufactured, the flatness requested within a lot for consecutive processing of a plurality of substrates is not necessarily a uniformly high flatness and may be a low flatness compared to other substrates.

If planarization is consecutively performed on all these substrates to meet high requirement specifications, it can take an unnecessary amount of time.

### SUMMARY

The present disclosure provides a planarization method, a planarization system, and an article manufacturing method that can efficiently respond to a request for different flatnesses and reduce processing time.

A first aspect of the present disclosure relates to a planarization method. The planarization method uses a planarization system including a plurality of processing apparatuses. The planarization system is configured to be able to perform, using the plurality of processing apparatuses, at least two steps of forming a first planarizing film by bringing a superstrate into contact with a curable composition placed on a first substrate, and spin coating a liquid film of a curable composition on a second substrate using a spin coat method. The planarization method includes performing any one of the at least two steps to perform planarization of the first substrate or the second substrate.

A second aspect of the present disclosure relates to a planarization method. The planarization method uses a planarization system including a plurality of processing apparatuses. The planarization system is configured to be able to perform, using the plurality of processing apparatuses, at least two steps of forming a first planarizing film by bringing a superstrate into contact with a curable composition placed on a first substrate, and forming a second planarizing film by forming a liquid film obtained as a result of merging a plurality of liquid droplets of a curable composition placed on a second substrate and then curing the liquid film. The planarization method includes performing any one of the at least two steps to perform planarization of the first substrate or the second substrate.

A third aspect of the present disclosure relates to a planarization system. The planarization system that performs planarization of a first substrate or a second substrate includes: a conveyance mechanism configured to convey the first substrate or the second substrate; a planarization apparatus configured to form a planarizing film by bringing a superstrate into contact with a curable composition placed on the first substrate; and a spin coater configured to spin coat a liquid film of a curable composition on the second substrate using a spin coat method, wherein the conveyance mechanism is configured to convey the first substrate or the second substrate to any one of the spin coater and the planarization apparatus, and the any one of the spin coater and the planarization apparatus is configured to perform a process on the first substrate or the second substrate.

A fourth aspect of the present disclosure relates to a planarization system. The planarization system includes: a liquid droplet placement apparatus configured to place a plurality of liquid droplets of a curable composition on a first substrate; a planarization apparatus configured to form a planarizing film by bringing a superstrate into contact with the plurality of liquid droplets of the curable composition placed on the first substrate by the liquid droplet placement apparatus; a spin coater configured to spin coat a liquid film of a curable composition on a second substrate using a spin coat method; a heat treatment apparatus configured to perform heat treatment to cure the curable composition placed on the first substrate or the second substrate by the spin coater or the liquid droplet placement apparatus; and a conveyance mechanism configured to convey the first substrate or the second substrate to the spin coater, the heat treatment apparatus, the liquid droplet placement apparatus, and the planarization apparatus, wherein the conveyance mechanism is configured to convey the first substrate or the second substrate to any one of the spin coater, the heat treatment apparatus, the liquid droplet placement apparatus, and the planarization apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram that shows the configuration of a planarization system.

FIG. 2A is a diagram that shows the configuration of a carry-in section, and FIG. 2B is a diagram that shows the configuration of a placement section.

FIG. 3 is a diagram for illustrating a process during which a substrate is conveyed from the carry-in section to a supply section.

FIG. 4 is a diagram for illustrating a process during which a substrate is conveyed from the supply section to a planarization apparatus.

FIG. 5 is a diagram for illustrating a process during which a substrate is conveyed from the planarization apparatus to the carry-in section.

FIG. 6 is a timing chart of conveyance of a plurality of substrates.

FIGS. 7A to 7E are diagrams for illustrating a substrate swap operation.

FIG. 8 is a diagram that shows a process during which a die is conveyed to a planarization apparatus via the placement section.

FIG. 9 is a diagram that shows a process during which a die is conveyed to the planarization apparatus without passing through the placement section.

FIG. 10 is a diagram that shows the configuration of a planarization system.

FIGS. 11A to 11D are diagrams for illustrating planarization.

FIG. 12 is a diagram that shows the configuration of a planarization apparatus.

FIG. 13 is a schematic diagram that shows a plurality of types of planarization performed in the planarization system of an embodiment and differences in flatness obtained from the types of planarization.

FIG. 14 is a schematic diagram that shows a process during which a plurality of types of planarization is performed on a plurality of substrates within a lot.

### DESCRIPTION OF THE EMBODIMENTS

Hereinafter, embodiments will be described in detail with reference to the attached drawings. The following embodiments are not intended to limit the disclosure according to the appended claims. A plurality of features is described in each embodiment; however, not all the plurality of features is indispensable to the disclosure, and the plurality of features may be used in any combination. Like reference signs denote the identical or similar components in the attached drawings, and the repeated description is omitted.

A plurality of types of planarization that can be performed in a planarization system of the present disclosure will be described in detail below.

### First Method of Planarization

First, an overview of inkjet adapted planarization (IAP), which is a first method of the planarization of the present embodiment, will be described. A pattern previously formed on a substrate and under a photoresist coated thereon has an irregular profile due to a pattern formed in a previous step, and in the case of a typical logic process wafer, there are irregularities due to the pattern of about 80 nm to about 100 nm. Level differences due to a gentle undulation of an entire substrate can be corrected by the focus follow-up function of a scan exposure device used in a photolithography process. However, the fine-pitched irregularities that fall within the exposure slit area of the exposure device cannot be corrected by the focus follow-up function, and, if the amount of the irregularities is large, there is a risk of falling outside the depth of focus (DOF) of the exposure device. Generally, methods of forming a planarization layer, such as spin on carbon (SOC) and chemical mechanical polishing (CMP), have been used as a method of smoothing a pattern previously formed on a substrate and under a photoresist coated thereon. However, the existing technology has a drawback of not being able to obtain sufficient planarization performance, and the difference in base irregularities due to multilayering is likely to further increase in the future.

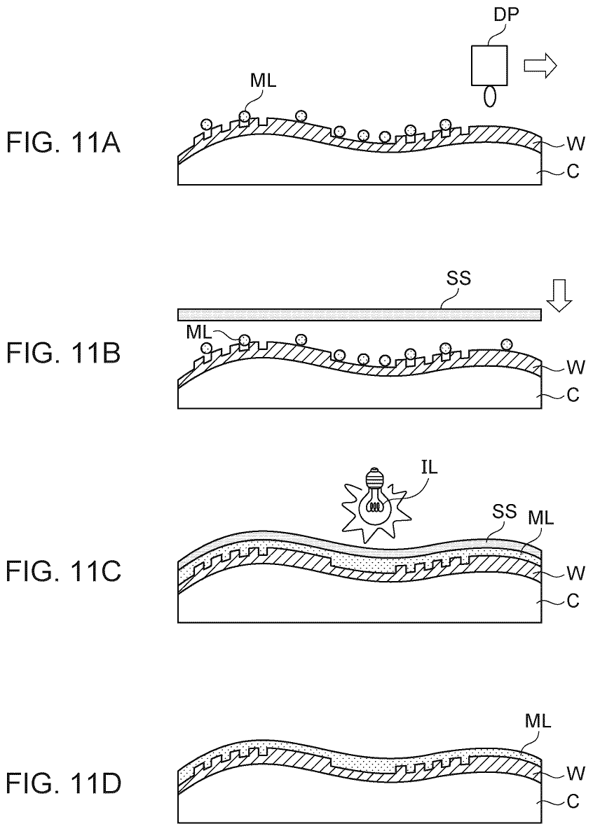

To address the drawback, a planarization apparatus that applies a jet and flash imprint lithography (JFIL) technology to planarize substrates has been being considered. An overview of planarization using the JFIL technology will be described with reference to FIGS. 11A to 11D. In the planarization using the JFIL technology, a substrate can be planarized through a supply step using a liquid droplet placement apparatus, shown in FIG. 11A, a contact step shown in FIG. 11B, a curing step shown in FIG. 11C, and a separation step shown in FIG. 11D. In FIGS. 11A to 11D, a circuit pattern is already formed on the surface of a substrate W chucked by a substrate chuck C, and there can be irregularities due to a pattern of, for example, about 80 nm to about 100 nm.

The requirements of a planarization apparatus in the present embodiment are to planarize the surface irregularities due to the pattern.

In the supply step shown in FIG. 11A, a composition ML that is a moldable material is supplied from a liquid droplet placement apparatus (dispenser) DP onto the surface of the substrate W chucked by the substrate chuck C. Here, it is illustrated that the composition ML is supplied from the dispenser DP to the surface of the substrate W on the substrate chuck C; however, in the embodiments (described later), the composition ML is supplied in a liquid droplet placement apparatus (supply section) 109 that is a module different from the planarization apparatus that performs planarization.

In the contact step shown in FIG. 11B, a superstrate SS that is a flat member (patternless member) with a flat surface having an outside diameter equal to or greater than that of the substrate W and having no pattern is brought into contact with the composition ML. A superstrate is also called a “planar template”. This contact presses the superstrate SS against the entire substrate surface. As a result, the composition ML spreads in a layer (referred to as “filling”or “spread”).

In the curing step shown in FIG. 11C, ultraviolet light from a light source IL is applied at a time (or as a repetition of partial exposure) over the entire surface of the substrate W in a state where the superstrate SS is in contact with the composition ML on the substrate W. As a result, the layered composition ML cures.

In the separation step shown in FIG. 11D, the superstrate SS is separated from the cured composition ML on the substrate W. Thus, the surface irregularities due to the pattern of the substrate W are planarized. Here, it is not intended to correct the flatness of components with a low spatial frequency, like the profile of the entire substrate is distorted relative to an absolute plane. For such components, nonplanar components are compensated by focus follow-up control of the exposure device in a subsequent pattern formation step.

A planarization step that includes the above contact step, curing step, and separation step is referred to as a first planarization step in the specification.

In this way, the planarization using the imprint technology is a technology for planarizing a composition on the nano order by supplying a composition according to level differences of the substrate, bringing a flat and thin member called a superstrate into contact with the supplied composition, and curing the composition.

The first planarization step may further include a heat curing step of further curing the composition by heating the film of the composition ML on the substrate that has been subjected to the curing step by light. In that case, the separation step of separating the superstrate SS from the composition ML may be performed either before the heat curing step or may be performed after the heat curing step. When there are irregularities on the surface of the substrate W, the surface of the planarizing film of the composition ML can have, for example, slight irregularities of less than or equal to 10 nm.

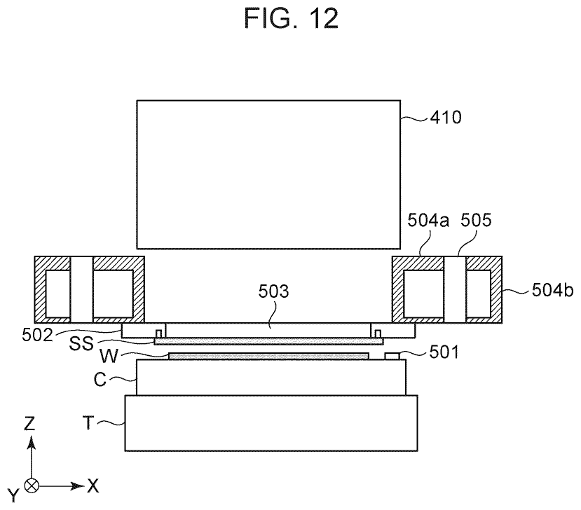

FIG. 12 is a diagram that shows the configuration of a processing apparatus that performs the planarization as described above. In the specification and the drawings, directions are indicated in an XYZ coordinate system of which a horizontal plane is an XY plane.

In the planarization apparatus, the surface of a substrate that is a processing target is supported so as to be parallel to the horizontal plane (XY plane). Therefore, hereinafter, directions orthogonal to each other within a plane along a holding surface for the substrate in the planarization apparatus are defined as an X-axis and a Y-axis, and a direction perpendicular to the X-axis and the Y-axis is defined as a Z-axis. Hereinafter, directions respectively parallel to the X-axis, the Y-axis, and the Z-axis in the XYZ coordinate system are referred to as X direction, Y direction, and Z direction, and a rotation directions around the X-axis, a rotation direction around the Y-axis, and a rotation direction around the Z-axis are respectively referred to as θX direction, θY direction, and θZ direction.

In FIG. 12, the superstrate SS is a flat member (patternless member) and can serve as a flat reference surface after planarization. In the present embodiment, the substrate chuck C is mounted on a substrate stage T. Sensors 501 that measure an upper side in the Z direction are arranged on the substrate chuck C in, for example, a two-channel layout in the depth direction of the sheet. The position in the Z direction and leveling (θX, θY) of the superstrate SS can be measured by these sensors 501. With these sensors 501, it is possible to also measure the amount of positional deviation of the superstrate SS in the XY directions relative to the chuck 502 by observing the edge part of the superstrate SS while scanning the substrate stage T in the Y direction.

Above the superstrate SS, there is a cavity 503 partitioned by a transparent member from an exposure light source (which corresponds to the light source IL of FIG. 11C) included in a lighting and spread observation system 410. When the superstrate SS is brought into contact with the composition on the substrate W, the inside of the cavity 503 is set to a positive pressure relative to atmospheric pressure. As a result, the superstrate SS takes on a convex shape relative to the substrate W, so it is possible to bring the center of the substrate into contact first, with the result that it is possible to reduce air trapped between the superstrate SS and the composition. A movable element 504a of a linear motor is fixed to the chuck 502. The movable element 504a can move relative to a stator 504b of the linear motor via a spring hinge 505. The linear motor configured in this way is subjected to position control using a position sensor (not shown). Three sets of the movable element 504a, the stator 504b, the spring hinge 505, and the position sensor are installed in one planarization apparatus. With this configuration, in the contact step and the separation step, positioning of the chuck 502 in three axes, that is, the Z-axis, θX-axis, and θY-axis, is performed in accordance with a predetermined driving profile.

The lighting and spread observation system 410 is disposed above the superstrate SS. The lighting and spread observation system 410 can include an exposure light source and an optical system for observing the spread state of the composition.

### Second Method: Performing First Planarization Step Twice Using First Method

Through hardening shrinkage or the like during heat curing of the composition ML, when the flatness does not satisfy the requested specification through single planarization, additional planarization can be performed.

After the supply step shown in FIG. 11A, the contact step shown in FIG. 11B, the curing step shown in FIG. 11C, the separation step shown in FIG. 11D, and the heating step that correspond to the first planarization step are performed, the same substrate W is subjected again to the supply step, the contact step, the curing step, the separation step, and the heating step.

As a result, planarization that provides a higher flatness than single planarization can be performed.

### Third Method: Planarization Using Spin Coat Method

The third method can include a liquid film formation step of spin coating a liquid film on the substrate W using the spin coat method, and a curing step of curing the liquid film in a state where the upper surface of the liquid film is exposed to a space above the liquid film. Examples of the material used to form a liquid film include a spin on carbon (SOC) material and a spin on glass (SOG) material. The curing step can include a liquid film curing step of curing a liquid film by heating the liquid film.

### Fourth Method: Planarization Using Reflow of Liquid Droplets

The fourth method can include the supply step shown in FIG. 11A and a curing step of curing a liquid film in a state where the upper surface of the liquid film is exposed to a space above the formed liquid film. The liquid film formation step can include a placement step of placing liquid droplets of a curable composition on the substrate W, and a waiting step of waiting until a liquid film is formed from the liquid droplets in a state where the liquid droplets are exposed to a space above. The curing step can include a liquid film curing step of curing a liquid film by heating the liquid film.

In the waiting step, the process can wait until a plurality of liquid droplets discretely placed spreads out and a liquid film is formed on the substrate. At this time, by performing heat treatment, the viscosity of the curable composition reduces to increase the fluidity, so it is possible to shorten a waiting time. The fourth method is to form a planarizing film by using the spread (reflow) of liquid droplets placed on the substrate without using a superstrate used in the first method and the second method. The specification refers to a second planarization step of forming a planarizing film by forming a liquid film obtained as a result of merging a plurality of liquid droplets of a curable composition placed on the substrate and then curing the liquid film.

Japanese Patent Laid-Open No. 2023-090491 describes a curable composition (A) as a liquid material. All matters described in Japanese Patent Laid-Open No. 2023-090491 are incorporated by reference into this specification as disclosed matters.

The curable composition (A) is a composition that includes at least a component (a) that is a polymerizable compound. The curable composition (A) may further include a component (b) that is a polymerization initiator, a non-polymerizable compound (c), and a component (d) that is a solvent. The components (a) to (c) can be non-volatile components, and the component (d) can be a volatile component.

The component (a) is a polymerizable compound. A polymerizable compound is a compound that reacts with a polymerizing factor (such as a radial) produced from a polymerization initiator (component (b)) to form a film composed of a polymer compound through a chain reaction (polymerization reaction). A compound that voluntarily produces a polymerizing factor and polymerizes when heated can also be used as a component (a). Examples of the polymerizable compound include a radical polymerizable compound. The polymerizable compound that is the component (a) may be composed of only one polymerizable compound or may be composed of multiple polymerizable compounds. Examples of the radical polymerizable compound include (meth)acrylic compounds, styrene compounds, vinyl compounds, allyl compounds, fumaric compounds, and maleic compounds.

The component (b) is a polymerization initiator. The polymerization initiator may be a photopolymerization initiator or may be a thermal polymerization initiator. The photopolymerization initiator is a compound that senses light of a predetermined wavelength to generate the above-described polymerizing factor (radical). Specifically, the photopolymerization initiator is a polymerization initiator (radical generator) that generates radicals by receiving light (infrared light, visible light, ultraviolet light, far-ultraviolet light, X-rays, charged particle beams such as electron beams, and radiation beams). The thermal polymerization initiator is a polymerization initiator (radical generator) that generates radicals using heat. The component (b) may be composed of only one polymerization initiator or may be composed of multiple polymerization initiators.

The component (c) can further include a non-polymerizable compound. Examples of the component (c) include a compound that does not have a polymerizable functional group, such as a (meth)acryloyl group, and that does not have the ability to sense light of a predetermined wavelength to generate the above-described polymerizing factor (radical). Examples of the non-polymerizable compound include a sensitizer, a hydrogen donor, an internal release agent, an oxidation inhibitor, a polymer component, and other additives. Multiple types of the above-described compounds may be included as the component (c).

The component (d) is a volatile component and includes a solvent with a boiling point of 80° C. or higher and lower than 250° C. under normal pressure. The component (d) can be a solvent in which the component (a), the component (b), and the component (c) are dissolved. Examples of the component (d) include alcohol solvents, ketone solvents, ether solvents, ester solvents, and nitrogen-containing solvents. One type can be used alone as the component (d) or a combination of two or more types can be used as the component (d). In other words, the component (d) can include one or more solvents. The boiling point of the component (d) under normal pressure is higher than or equal to 80° C. and is preferably higher than or equal to 140° C. If the boiling point of the component (d) under normal pressure is lower than 80° C., the volatilization rate in the waiting step is too high. This may cause the component (d) to volatilize before the liquid droplets of the curable composition (A) merge with each other and may cause the liquid droplets of the curable composition (A) not to merge with each other. If the boiling point of the component (d) under normal pressure is higher than or equal to 250° C., the volatilization of the component (d) is insufficient in the waiting step. This may cause the component (d) to remain in a cured material of the curable composition (A).

### Fifth Method: Spin Coating After Planarization of First Method

In the fifth method, similar to the first method, the supply step shown in FIG. 11A is performed on a substrate W, and the substrate can be planarized through the contact step shown in FIG. 11B, the curing step shown in FIG. 11C, and the separation step shown in FIG. 11D, which are included in the first planarization step. After the planarization is performed, the process can further include a liquid film formation step of spin coating a liquid film on the substrate W using the spin coat method, and a curing step of curing the liquid film in a state where the upper surface of the liquid film is exposed to a space above the liquid film.

Examples of the material used to form a liquid film include a spin on carbon (SOC) material and a spin on glass (SOG) material. The curing step can include a liquid film curing step of curing a liquid film by heating the liquid film.

The present embodiment can selectively perform these first to fifth methods using a planarization system (described later).

In other words, the present embodiment includes the following configurations.
(1) A planarization system is configured to be able to perform, using a plurality of processing apparatuses, at least two steps of a first planarization step, included in the first method, the second method, and the fifth method, of forming a planarizing film by bringing a superstrate into contact with a curable composition placed on a substrate, and a spin coat step, included in the third method and the fifth method, of spin coating a liquid film of a curable composition on the substrate using a spin coat method, and any one of the two steps is selected to perform planarization of the substrate in the planarization system.

There are a step of obtaining a first treated substrate by performing planarization, including the first planarization step, on the substrate and a step of obtaining a second treated substrate different in flatness from the first treated substrate by performing planarization, including the spin coat step, on the substrate.
(2) A planarization system is configured to be able to perform, using a plurality of processing apparatuses, at least two steps of a first planarization step, included in the first method, the second method, and the fifth method, of forming a planarizing film by bringing a superstrate into contact with a curable composition placed on a substrate and a second planarization step, included in the fourth method, of forming a planarizing film by forming a liquid film obtained as a result of merging a plurality of liquid droplets of a curable composition placed on the substrate and then curing the liquid film, and any one of the two steps is selected to perform planarization of the substrate in the planarization system.

There are a step of obtaining a first treated substrate by performing planarization, including the first planarization step, on the substrate and a step of obtaining a third treated substrate different in flatness from the first treated substrate by performing planarization, including the second planarization step, on the substrate.
(3) A planarization system is configured to be able to perform, using a plurality of processing apparatuses, at least three steps of a first planarization step, included in the first method, the second method, and the fifth method, of a first planarization step of forming a planarizing film by bringing a superstrate into contact with a curable composition placed on a substrate, a second planarization step, included in the fourth method, of forming a planarizing film by forming a liquid film obtained as a result of merging a plurality of liquid droplets of a curable composition placed on the substrate and then curing the liquid film, and a spin coat step, included in the third method and the fifth method, of spin coating a liquid film of a curable composition on the substrate using a spin coat method, and any one of the three steps is selected to perform planarization of the substrate in the planarization system.

There are a step of obtaining a first treated substrate by performing planarization, including the first planarization step, on the substrate, a step of obtaining a second treated substrate different in flatness from the first treated substrate by performing planarization, including the spin coat step, on the substrate, and a step of obtaining a third treated substrate different in flatness from both the first treated substrate and the second treated substrate by performing planarization, including the second planarization step, on the substrate.

Furthermore, the planarization system is configured to select any one of a liquid droplet placement step, a first planarization step, a spin coat step, and a heat treatment step to process a substrate according to a requested flatness of the substrate, and consecutively process a plurality of substrates.

More specifically, the planarization system is configured to perform a process selected from among at least any two processes, as a process on a substrate, of a first process of performing a process on a substrate in order of a liquid droplet placement step, a first planarization step, and a heat treatment step to perform the first method, a second process of performing a process on a substrate in order of a liquid droplet placement step, a planarization step, a heat treatment step, a liquid droplet placement step, and a first planarization step to perform the second method, a third process of performing a process on a substrate in order of a spin coat step and a heat treatment step to perform the third method, a fourth process of performing a process on a substrate in order of a liquid droplet placement step and a second planarization step to perform the fourth method, and a fifth process of performing a process on a substrate in order of a liquid droplet placement step, a first planarization step, a heat treatment step, and a spin coat step to perform the fifth method.

The planarization system can be configured to perform a process selected from among at least any three processes of the first method to the fifth method, as a process for each of a plurality of substrates consecutively processed. The planarization system can be configured to perform a process selected from among four methods of the first method to the fifth method or five methods of the first method to the fifth method, on each substrate.

### Configuration of Planarization System

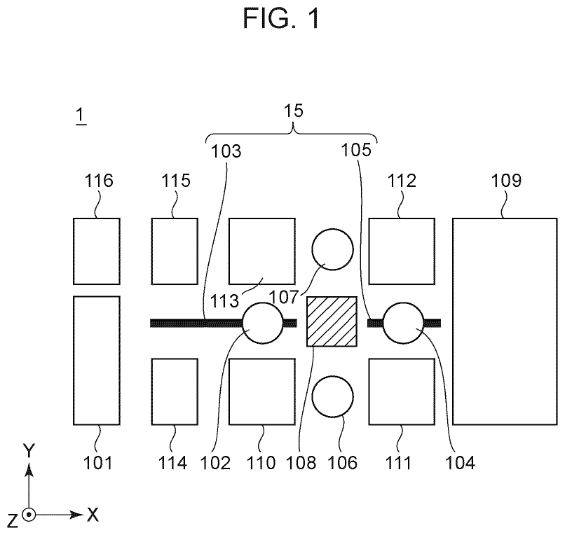

FIG. 1 is a diagram that shows the configuration of a planarization system 1 in the embodiment. The planarization system 1 has a cluster configuration in which a plurality of processing apparatuses works together.

The planarization system 1 is a hybrid planarization system that forms a planarizing film with a single or double layer structure using the above-described five types of methods.

The planarization system 1 can include a first planarization apparatus 110 and a spin coater 116. The planarization system 1 may include one or more additional first planarization apparatuses 110 and/or one or more additional spin coaters 116.

In the example shown in FIG. 1, the planarization system 1 includes four similar planarization apparatuses and a spin coater 116. A first planarization apparatus 110, a second planarization apparatus 111, a third planarization apparatus 113, and a fourth planarization apparatus 112 each can have the configuration shown in FIG. 12.

The number of first planarization apparatuses 110 and the number of spin coaters 116 can be determined according to a processing time of each on the substrate W.

The first planarization apparatus 110 forms a planarizing film by bringing a superstrate SS into contact with a plurality of liquid droplets of a curable composition placed on the substrate W. The spin coater 116 spin coats a liquid film using the spin coat method. A method of spin coating a liquid film using the spin coat method can follow the third method.

The planarization system 1 can include a heat treatment apparatus 114 that performs heat treatment to cure a liquid film formed by the spin coater 116. The planarization system 1 can also include a conveyor robot TS that conveys substrates W. The conveyor robot TS may include one or more robots HR that convey or manipulate substrates W. The conveyor robot TS can include a relay section RS that relays substrates W and a pre-aligner PA that pre-aligns substrates W.

The planarization system 1 may further include a liquid droplet placement apparatus 109 that places a plurality of liquid droplets of a curable composition on a substrate W. The substrate W on which a plurality of liquid droplets of a curable composition is placed by the liquid droplet placement apparatus 109 can be supplied by the conveyor robot TS to a first planarization apparatus 110 selected from among the plurality of first planarization apparatuses 110. Alternatively, the first planarization apparatus 110 may have a liquid droplet placement function that places a plurality of liquid droplets of a curable composition on a substrate W.

The heat treatment apparatus 114 may perform not only heat treatment to cure a liquid film spin coated by the spin coater 116 but also perform heat treatment to further cure a planarizing film formed by the first planarization apparatus 110. Alternatively, the planarization system 1 may include an additional heat treatment apparatus that performs heat treatment to further cure a planarizing film formed by the first planarization apparatus 110. Alternatively, the first planarization apparatus 110 may have a heat treatment function to perform an additional heat treatment.

The planarization system 1 can further include a close adhesion layer forming apparatus 115 that forms a close adhesion layer on a substrate W supplied to the first planarization apparatus 110 and the spin coater 116. Here, the substrate W on which the close adhesive layer is formed by the close adhesion layer forming apparatus 115 can be supplied to the first planarization apparatus 110 and then supplied to the spin coater 116. Alternatively, the substrate W may be supplied to the spin coater 116 and then supplied to the first planarization apparatus 110.

The planarization system 1 includes a carry-in section 101 for carrying a substrate or a flat member into the planarization system 1. The carry-in section 101 can be a relay section to which a substrate conveyed from a substrate conveyance module called an equipment front end module (EFEM) is supplied. The carry-in section 101 can include a substrate relay slot and a pre-alignment device that can relay a substrate. The pre-alignment device configured in the carry-in section 101 performs pre-alignment of a substrate that is conveyed to the supply section 109.

The planarization system 1 can include a control unit CNT that controls component elements (a planarization apparatus PS, a spin coater SC, a liquid droplet placement apparatus JM, the heat treatment apparatus 114, a close adhesion layer forming apparatus VC, TS, LD, and the like) that make up the planarization system 1. The control unit CNT can be made up of, for example, a programmable logic device (PLD) such as a field programmable gate array (FPGA), an application specific integrated circuit (ASIC), or a general purpose or dedicated computer with a program embedded, or a combination of all or some of these.

The heat treatment apparatus 114, the close adhesion layer forming apparatus 115, and the plurality of first planarization apparatuses 110 can be disposed between a first region where the carry-in section 101 is disposed and a second region where the liquid droplet placement apparatus 109 is disposed. The spin coater 116 can be disposed in the first region. The heat treatment apparatus 114 and the close adhesion layer forming apparatus 115 can be disposed in a third region between the first region and the second region. The plurality of first planarization apparatuses 110 can be disposed in a fourth region between the third region and the second region.

The planarization system 1 can include a conveying path 15 through which a substrate or a flat member is conveyed between one end where the carry-in section 101 is positioned and the other end where the supply section 109 is positioned. In the present embodiment, the conveying path 15 is made up of a first conveying path 103 and a second conveying path 105 both extending in the X direction.

The planarization system 1 can include a placement section 108 disposed in the middle of the conveying path. The placement section 108 is configured to be able to place a substrate or a flat member that is carried into any one of the plurality of planarization apparatuses. In the present embodiment, the placement section 108 is disposed between the first conveying path 103 and the second conveying path 105. The placement section 108 is configured to perform pre-alignment of a substrate placed. In an example, the placement section 108 can include a substrate relay slot and a pre-alignment device that can relay substrates. The pre-alignment device configured in the placement section 108 performs pre-alignment of a substrate conveyed to one of the planarization apparatuses. Therefore, the placement section 108 serves not just as a placement section, but also plays a role as an adjustment section having a pre-alignment function for substrates.

The planarization system 1 includes a first conveyor robot 102 that is a conveyance mechanism for conveying a substrate or a flat member. The first conveyor robot 102 is disposed on the conveying path between the carry-in section 101 and the placement section 108, and is configured to convey a substrate or a flat member. The first conveyor robot 102 is mounted on the first conveying path 103, and, even when the distance between the carry-in section 101 and the placement section 108 is long, the first conveyor robot 102 can convey a substrate by moving along the first conveying path 103.

The planarization system 1 includes a second conveyor robot 104. The second conveyor robot 104 is disposed on the conveying path between the placement section 108 and the supply section 109, and is configured to convey a substrate or a flat member. The second conveyor robot 104 is mounted on the second conveying path 105, and, even when the distance between the placement section 108 and the supply section 109 is long, the second conveyor robot 104 can convey a substrate by moving along the second conveying path 105.

The effective stroke of the first conveying path 103 and the effective stroke of the second conveying path 105 may be different.

However, the time taken to move the maximum stroke of each conveying path needs to be within the time taken for the conveyor robot to make a 180° turn. This is because apparatus throughput decreases if the moving time of each conveying path becomes longer than the turning time of the conveyor robot.

The first planarization apparatus 110 is disposed within the conveyance range of a substrate or a flat member by the first conveyor robot 102. As a result, a substrate or a flat member is conveyed from the first conveyor robot 102 to the first planarization apparatus 110. The second planarization apparatus 111 is disposed within the conveyance range of a substrate or a flat member by the second conveyor robot 104. As a result, a substrate or a flat member is conveyed from the second conveyor robot 104 to the second planarization apparatus 111.

In the present embodiment, the first conveyor robot 102 is configured to convey a substrate or a flat member among the carry-in section 101, the placement section 108, and the first planarization apparatus 110. The second conveyor robot 104 is configured to convey a substrate or a flat member among the placement section 108, the supply section 109, and the second planarization apparatus 111.

The planarization system 1 further includes a third conveyor robot 106. The third conveyor robot 106 is configured to convey a substrate or a flat member among the first planarization apparatus 110, the second planarization apparatus 111, and the placement section 108.

In the present embodiment, the third planarization apparatus 113 is disposed within the conveyance range of a substrate or a flat member by the first conveyor robot 102, and the fourth planarization apparatus 112 is disposed within the conveyance range of a substrate or a flat member by the second conveyor robot 104. The planarization system 1 may further include a fourth conveyor robot 107 configured to convey a substrate or a flat member among the third planarization apparatus 113, the fourth planarization apparatus 112, and the placement section 108.

The supply section 109 supplies a composition as a moldable material to the surface of a substrate. The supply section 109 can include a stage that holds and moves a substrate, and a dispenser that dispenses a composition. The dispenser can be a jetting module that supplies a composition in the form of liquid droplets. The relative scan drive between the stage and the dispenser is performed multiple times, with the result that a composition is supplied across the entire surface of the substrate. At this time, it is possible to supply the composition while setting a distribution of the supply amount of the composition according to the placement of the relief pattern formed on the surface of the substrate. For example, the composition is supplied so that the density of liquid droplets is high in a part with a high ratio of recesses of the pattern on the substrate surface and is low in a part with a low ratio of recesses. Therefore, during the supply of the composition by the dispenser, substrate alignment measurement can be performed to align the position of the pattern previously formed on the substrate with the position of the density pattern of the composition supplied.

In the present embodiment, as shown in FIG. 1, the carry-in section 101, the placement section 108, and the supply section 109 are disposed in a line on the conveying path. The first planarization apparatus 110 and the second planarization apparatus 111 are arranged in line in a direction parallel to the direction in which the conveying path extends (X direction). FIG. 1 is a plan view of the planarization system 1 when viewed from above in the Z direction. In a side view in the Y direction, it can be understood that the first planarization apparatus 110 is disposed at a position between the carry-in section 101 and the placement section 108. In the side view, it can be understood that the second planarization apparatus 111 is disposed at a position between the placement section 108 and the supply section 109.

The third planarization apparatus 113 and the fourth planarization apparatus 112 are disposed on the opposite side of the first planarization apparatus 110 and the second planarization apparatus 111 across the conveying path. In the present embodiment, the third conveyor robot 106 and the fourth conveyor robot 107 are arranged in a line in a direction that intersects with the conveying path at a position where the placement section 108 is disposed. In other words, the third conveyor robot 106 and the fourth conveyor robot 107 are arranged in a line in the Y direction so as to sandwich the placement section 108. Here, the third conveyor robot 106 is disposed between the first planarization apparatus 110 and the second planarization apparatus 111, and the fourth conveyor robot 107 is disposed between the third planarization apparatus 113 and the fourth planarization apparatus 112.

Planarization in the first planarization apparatus 110, the second planarization apparatus 111, the third planarization apparatus 113, and the fourth planarization apparatus 112 will be described.

In each planarization apparatus, in the contact step, a superstrate SS having an outside diameter equal to or greater than that of a substrate is brought into contact with a composition and pressed against the entire surface of the substrate, thus promoting the composition to spread in a layer on the substrate. In the curing step, the composition is cured in a state where the superstrate SS is in contact with the composition on the substrate. The composition can be, for example, a photo-curable composition that cures by receiving ultraviolet light emitted from a light source (included in the lighting and spread observation system 410). In the separation step, the superstrate SS is separated from the cured composition on the substrate. As a result, the surface of the substrate is planarized.

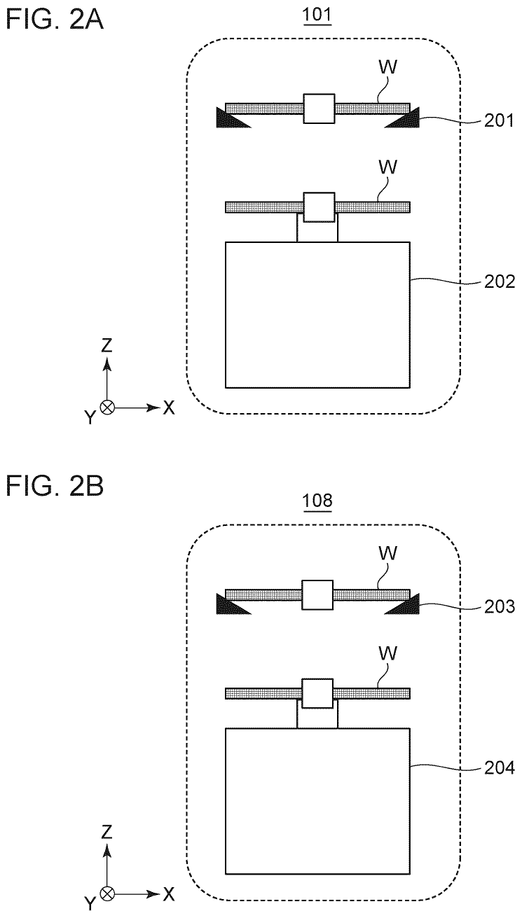

The configurations of the carry-in section 101 and the placement section 108 will be described with reference to FIGS. 2A and 2B. FIG. 2A is a diagram that shows the configuration of the carry-in section 101. FIG. 2B is a diagram that shows the configuration of the placement section 108. The carry-in section 101 can include a substrate placement portion 201 on which a substrate is placed, and a pre-alignment device 202 that is disposed below the substrate placement portion 201 and that performs pre-alignment of a substrate placed on the substrate placement portion 201. The placement section 108 can include a substrate placement portion 203 on which a substrate is placed, and a pre-alignment device 204 that is disposed below the substrate placement portion 203 and that performs pre-alignment of a substrate placed on the substrate placement portion 203. In each of the carry-in section 101 and the placement section 108, a multi-tier shelf capable of accommodating a plurality of substrates may be provided. The number of substrates that can be accommodated (the number of tiers of the shelf) in each of the carry-in section 101 and the placement section 108 may be the same or may be different. Here, the carry-in section 101 and the placement section 108 each are assumed so that a substrate is placed therein; however, the carry-in section 101 and the placement section 108 each may also be configured so that a superstrate SS is placed therein. The pre-alignment device 202 and the pre-alignment device 204 may have the same configuration or may have different configurations. In each of the carry-in section 101 and the placement section 108, the layout of the substrate placement portion and the pre-alignment device may be inverted.

### Description of Flow of Substrate Conveyance

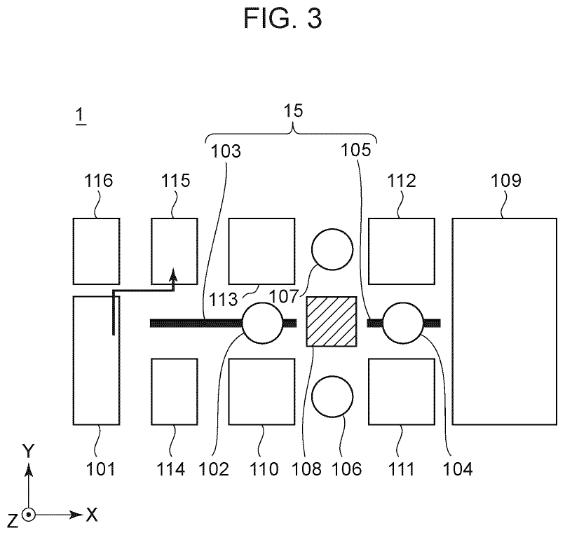

A process in which a substrate W is conveyed from the carry-in section 101 to the close adhesion layer forming apparatus 115 will be described with reference to FIG. 3. The movement of the substrate W can be controlled by the control unit CNT programmed in advance. First, a substrate W is conveyed to the carry-in section 101. At this time, the substrate W is placed on the pre-alignment device (not shown) of the carry-in section 101. The pre-aligned substrate W is placed on the substrate placement portion (not shown) of the close adhesion layer forming apparatus 115 by the first conveyor robot 102. The close adhesion layer forming apparatus may be made up of a sealable heating chamber, and applies the close adhesion layer forming material onto the substrate by vapor deposition or the like. The applied close adhesion layer forming material is caused to react with the substrate surface by heating to form a close adhesion layer that improves the adhesion with a curable composition that is a planarizing material on the substrate surface. This step can sometimes be omitted depending on planarization adopted, and, in this case, a substrate is conveyed to the next processing section without passing through the close adhesion layer forming apparatus 115.

For a process after this, the path to be conveyed is changed according to a requested flatness of the substrate. Specifically, for example, a process of performing the above-described first method to fifth method is selected, and the conveyance route is determined according to the selected process.

In other words, the conveyance mechanism conveys a substrate in conveyance order selected from among the following conveyance orders.
First conveyance order to convey a substrate in order of the liquid droplet placement apparatus, the planarization apparatus, and the heat treatment apparatus to perform the first method.
Second conveyance order to convey a substrate in order of the liquid droplet placement apparatus, the planarization apparatus, the heat treatment apparatus, the liquid droplet placement apparatus, and the planarization apparatus to perform the second method.
Third conveyance order to convey a substrate in order of the spin coater and the heat treatment apparatus to perform the third method.
Fourth conveyance order to convey a substrate in order of the liquid droplet placement apparatus and the heat treatment apparatus to perform the fourth method.
Fifth conveyance order to convey a substrate in order of the liquid droplet placement apparatus, the planarization apparatus, the heat treatment apparatus, and the spin coater to perform the fifth method.

Hereinafter, the process that is performed in each conveyance order will be described.

### Process of First Method in Accordance With First Conveyance Order

A substrate W processed by the close adhesion layer forming apparatus 115 is placed on the substrate placement portion 203 of the placement section 108. Subsequently, the substrate W placed in the placement section 108 is conveyed to the supply section 109 by the second conveyor robot 104. The supply section 109 performs a supply process to supply (dispense) a moldable material onto the conveyed substrate W.

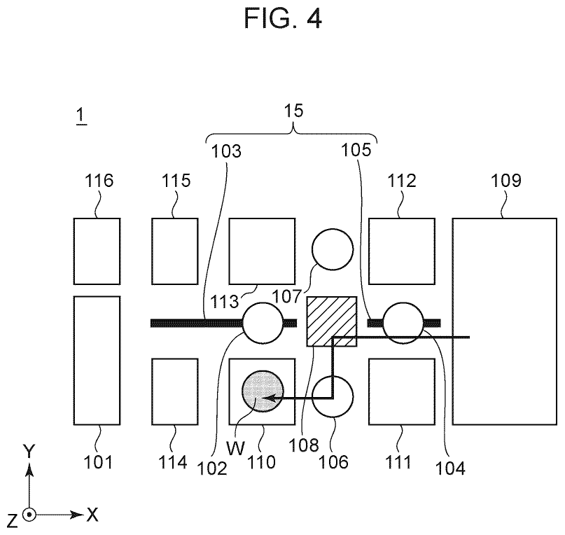

A process in which the substrate W is conveyed from the supply section 109 to the first planarization apparatus 110 will be described with reference to FIG. 4. The substrate W that has been subjected to the supply process at the supply section 109 is placed on the pre-alignment device 204 of the placement section 108 by the second conveyor robot 104. The third conveyor robot 106 receives the substrate W pre-aligned by the pre-alignment device 204 and conveys the substrate W to the first planarization apparatus 110, and then planarization is performed. The third conveyor robot 106 can convey a subsequent substrate to the second planarization apparatus 111. A substrate is conveyed by the fourth conveyor robot 107 to the fourth planarization apparatus 112 and the third planarization apparatus 113.

When the substrate is conveyed from the supply section 109 to the second planarization apparatus 111, the second conveyor robot 104 conveys the substrate from the supply section 109 to the second planarization apparatus 111 without passing through the placement section 108.

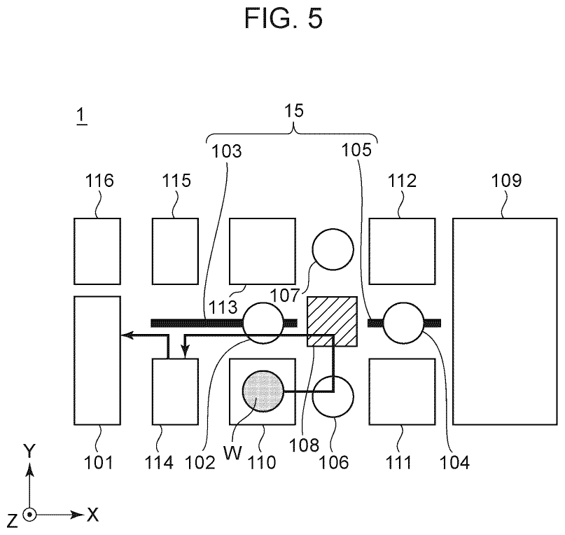

A process in which the substrate W is conveyed from the first planarization apparatus 110 to the carry-in section 101 will be described with reference to FIG. 5. The substrate W processed by the first planarization apparatus 110 is conveyed to the substrate placement portion 203 of the placement section 108 by the third conveyor robot 106. Subsequently, the substrate W placed on the substrate placement portion 203 is conveyed to a placement portion (not shown) of the heat treatment apparatus 114 by the first conveyor robot 102. The heat treatment apparatus 114 includes a sealable chamber. The heat treatment apparatus 114 is configured to be able to heat a substrate within the chamber to a high temperature (for example, 300° C. to 500° C.). The heat treatment apparatus 114 performs heat curing of the composition on the substrate. After heating, the temperature of the substrate is cooled, the substrate is conveyed to the substrate placement portion 201 of the carry-in section 101 by the first conveyor robot 102, and then the substrate is conveyed to outside the apparatus.

In other words, to perform the process of the first method, the conveyance mechanism conveys a substrate in the first conveyance order, that is, the order of the liquid droplet placement apparatus, the planarization apparatus, and the heat treatment apparatus.

### Process of Second Method in Accordance With Second Conveyance Order

Through hardening shrinkage during heating of a composition, when the flatness does not satisfy the requested specification, additional planarization can be performed.

After the heat curing in the heat treatment apparatus 114 in the above-described inkjet adapted planarization, the substrate is conveyed again to the supply section 109 by the first conveyor robot 102. The supply section 109 performs a supply process to supply a moldable material to the conveyed substrate W.

The substrate W that has been subjected to the supply process at the supply section 109 is placed on the pre-alignment device 204 of the placement section 108 by the second conveyor robot 104. The third conveyor robot 106 receives the substrate W pre-aligned by the pre-alignment device 204 and conveys the substrate W to the first planarization apparatus 110, and then planarization is performed again.

The substrate W processed by the first planarization apparatus 110 is conveyed to the substrate placement portion 203 of the placement section 108 by the third conveyor robot 106. Subsequently, the substrate W placed on the substrate placement portion 203 is conveyed to the placement portion (not shown) of the heat treatment apparatus 114 by the first conveyor robot 102, and the composition on the substrate is heat-cured. After heating, the temperature of the substrate is cooled, the substrate is conveyed to the substrate placement portion 201 of the carry-in section 101 by the first conveyor robot 102, and then the substrate is conveyed to outside the apparatus.

In other words, to perform the process of the second method, the conveyance mechanism conveys a substrate in the second conveyance order, that is, the order of the liquid droplet placement apparatus, the planarization apparatus, the heat treatment apparatus, the liquid droplet placement apparatus, and the planarization apparatus.

### Process of Third Method in Accordance With Third Conveyance Order

The substrate W processed by the close adhesion layer forming apparatus 115 is conveyed to the spin coater 116 by the first conveyor robot 102. The spin coater 116 supplies a moldable material to the conveyed substrate W and spin coats a liquid film using the spin coat method.

The substrate W processed by the spin coater 116 is conveyed to the placement portion (not shown) of the heat treatment apparatus 114 by the first conveyor robot 102, and the composition on the substrate is heat-cured. After heating, the temperature of the substrate is cooled, the substrate is conveyed to the substrate placement portion 201 of the carry-in section 101 by the first conveyor robot 102, and then the substrate is conveyed to outside the apparatus.

In other words, to perform the process of the third method, the conveyance mechanism conveys a substrate in the third conveyance order, that is, the order of the spin coater and the heat treatment apparatus.

### Process of Fourth Method in Accordance With Fourth Conveyance Order

A substrate W processed by the close adhesion layer forming apparatus 115 is placed on the substrate placement portion 203 of the placement section 108. Subsequently, the substrate W placed in the placement section 108 is conveyed to the supply section 109 by the second conveyor robot 104. The supply section 109 performs a supply process to supply (dispense) a moldable material onto the conveyed substrate W.

The substrate W that has been subjected to the supply process at the supply section 109 is conveyed to the first planarization apparatus 110 by the third conveyor robot 106, the process waits there until a curable composition forms a film on the substrate without using a superstrate SS, and planarization through a curing treatment using light is performed.

The substrate W processed by the first planarization apparatus 110 is conveyed to the substrate placement portion 203 of the placement section 108 by the third conveyor robot 106. Subsequently, the substrate W placed on the substrate placement portion 203 is conveyed to the placement portion (not shown) of the heat treatment apparatus 114 by the first conveyor robot 102, and the composition on the substrate is heat-cured. After heating, the temperature of the substrate is cooled, the substrate is conveyed to the substrate placement portion 201 of the carry-in section 101 by the first conveyor robot 102, and then the substrate is conveyed to outside the apparatus.

In other words, to perform the process of the fourth method, the conveyance mechanism conveys a substrate in the fourth conveyance order, that is, the order of the liquid droplet placement apparatus and the heat treatment apparatus.

### Process of Fifth Method in Accordance With Fifth Conveyance Order

A substrate W processed by the close adhesion layer forming apparatus 115 is placed on the substrate placement portion 203 of the placement section 108. Subsequently, the substrate W placed in the placement section 108 is conveyed to the supply section 109 by the second conveyor robot 104. The supply section 109 performs a supply process to supply (dispense) a moldable material onto the conveyed substrate W.

The substrate W that has been subjected to the supply process at the supply section 109 is placed on the pre-alignment device 204 of the placement section 108 by the second conveyor robot 104. The third conveyor robot 106 receives the substrate W pre-aligned by the pre-alignment device 204 and conveys the substrate W to the first planarization apparatus 110, and then planarization is performed.

The substrate W processed by the first planarization apparatus 110 is conveyed to the substrate placement portion 203 of the placement section 108 by the third conveyor robot 106. Subsequently, the substrate W placed on the substrate placement portion 203 is conveyed to the placement portion (not shown) of the heat treatment apparatus 114 by the first conveyor robot 102, and the composition on the substrate is heat-cured. After heating, the temperature of the substrate is cooled and is conveyed to the spin coater 116 by the first conveyor robot 102. The spin coater 116 supplies a moldable material to the conveyed substrate W and spin coats a liquid film using the spin coat method.

The substrate W processed by the spin coater 116 is conveyed to the placement portion (not shown) of the heat treatment apparatus 114 by the first conveyor robot 102, and the composition on the substrate is heat-cured. After heating, the temperature of the substrate is cooled, the substrate is conveyed to the substrate placement portion 201 of the carry-in section 101 by the first conveyor robot 102, and then the substrate is conveyed to outside the apparatus.

In other words, to perform the process of the fifth method, the conveyance mechanism conveys a substrate in the fifth conveyance order, that is, the order of the liquid droplet placement apparatus, the planarization apparatus, the heat treatment apparatus, and the spin coater.

### Flow of Process Selection

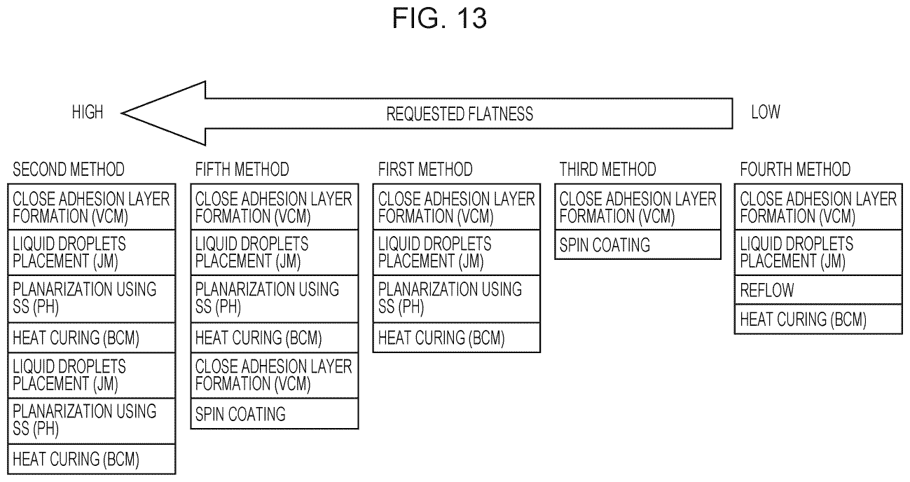

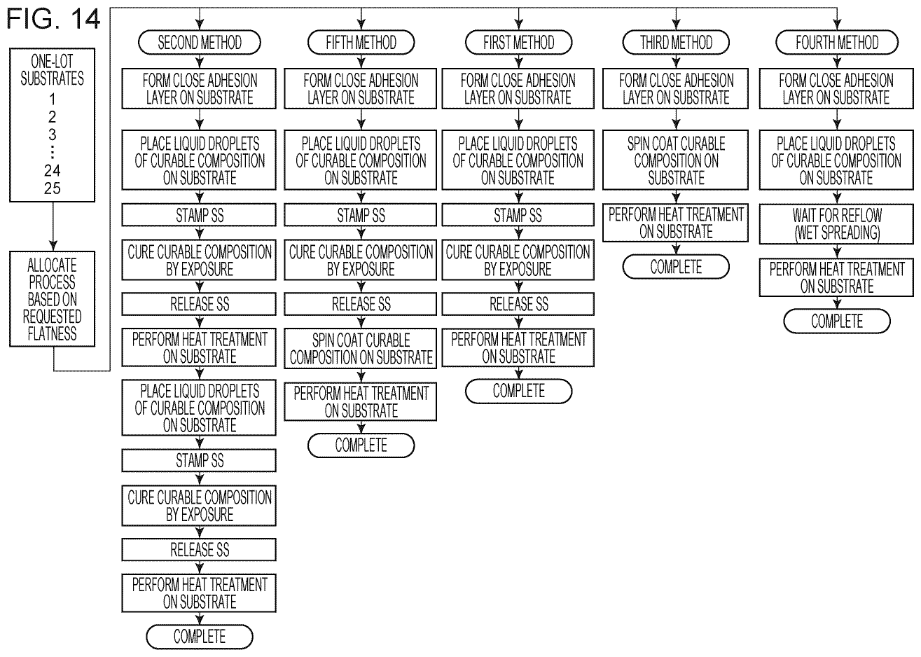

The flow of process selection when different processes are performed on a plurality of substrates to be processed within a single lot according to a requested flatness will be described with reference to FIGS. 13 and 14.

As shown in FIG. 13, assuming a case where any one of the first method to the fifth method is selected and performed using the planarization system of the first embodiment. The flatnesses of the treated substrates respectively obtained through the methods vary. For example, as shown in FIG. 13, the second method can provide substrate processing with the highest flatness, that is, a high flatness, and the flatness obtained gradually decreases (deteriorates) in order of the fifth method, the first method, the third method, and the fourth method. In other words, the system enables substrate processing with which the flatness obtained gradually decreases in this order. However, as shown in FIG. 14, the number of cycles of the process of each of the second method and the fourth method significantly differs from each other, and the time taken for the process and the resulting flatness tend to be proportional.

As shown in FIG. 14, each of the substrates within a lot (for example, 25 wafer substrates) may mixedly include substrates for which a high flatness is requested and substrates that can have a low flatness.

Here, according to a requested flatness of a substrate, the control unit CNT selects any one of the first method to the fifth method and controls the processing order and processing timing of each substrate.

As a result, it is possible to, for example, reduce the time taken for substrates that can be processed with a low flatness and efficiently perform planarization.

Based on the control flow of the selected method, each substrate is conveyed in the planarization system 1, and the process in each apparatus is performed.

### Second Embodiment

In the first embodiment, the process in which a specific one substrate W is conveyed and the flow of processing a plurality of substrates have been described. In the second embodiment, a process in which a plurality of substrates is consecutively conveyed will be described.

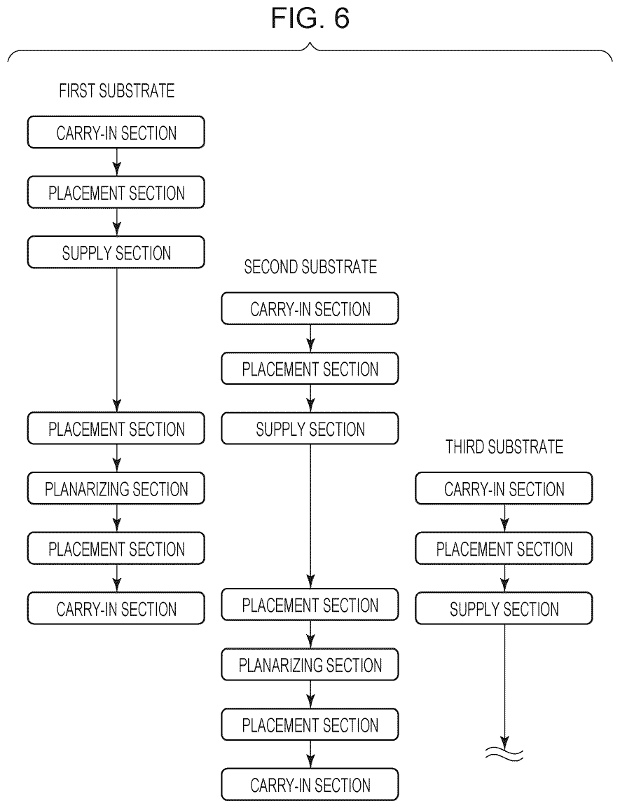

FIG. 6 is a timing chart of conveyance of a plurality of substrates. As described above, a single substrate is conveyed in order of the carry-in section 101, the placement section 108, the supply section 109, the placement section 108, the first planarization apparatus 110, the placement section 108, and the carry-in section 101. When the first substrate is loaded into the supply section 109, the second substrate is placed in the carry-in section 101. The dispensing process for the first substrate completes at the timing when the second substrate is loaded into the supply section 109. The first conveyor robot 102, the second conveyor robot 104, the third conveyor robot 106, and the fourth conveyor robot 107 each have two hands for holding a substrate. Therefore, for example, each of the third conveyor robot 106 and the fourth conveyor robot 107 can hold a substrate to be unloaded from the planarization apparatus while holding a substrate to be loaded into the planarization apparatus, so a substrate swap operation is possible. The details of the substrate swap operation will be described later. As a result, the substrate swap operation is performed at the timing when the second substrate is loaded into the supply section 109. Thus, it is possible to collect the first substrate from the supply section 109. The collected first substrate is conveyed to the first planarization apparatus 110. The number of substrates processed per hour in the supply section 109 is more than twice the number of substrates processed per hour in each of the plurality of planarization apparatuses. In an example, a processing time per substrate in the supply section 109 is shorter than or equal to ¼ of a processing time per substrate in each of the first planarization apparatus 110, the second planarization apparatus 111, the third planarization apparatus 113, and the fourth planarization apparatus 112. Therefore, while the planarization of the first substrate is being performed in the first planarization apparatus 110, the second substrate that has been subjected to the supply process in the supply section 109 is conveyed to the second planarization apparatus 111. While the planarization of the second substrate is being performed in the second planarization apparatus 111, the third substrate that has been subjected to the supply process in the supply section 109 is conveyed to the fourth planarization apparatus 112. While the planarization of the third substrate is being performed in the fourth planarization apparatus 112, the fourth substrate that has been subjected to the supply process in the supply section 109 is conveyed to the third planarization apparatus 113. At the timing when the fifth substrate is conveyed to the first planarization apparatus 110, the planarization of the first substrate completes, and the first substrate is collected through the substrate swap operation. In this way, a plurality of substrates is consecutively conveyed.

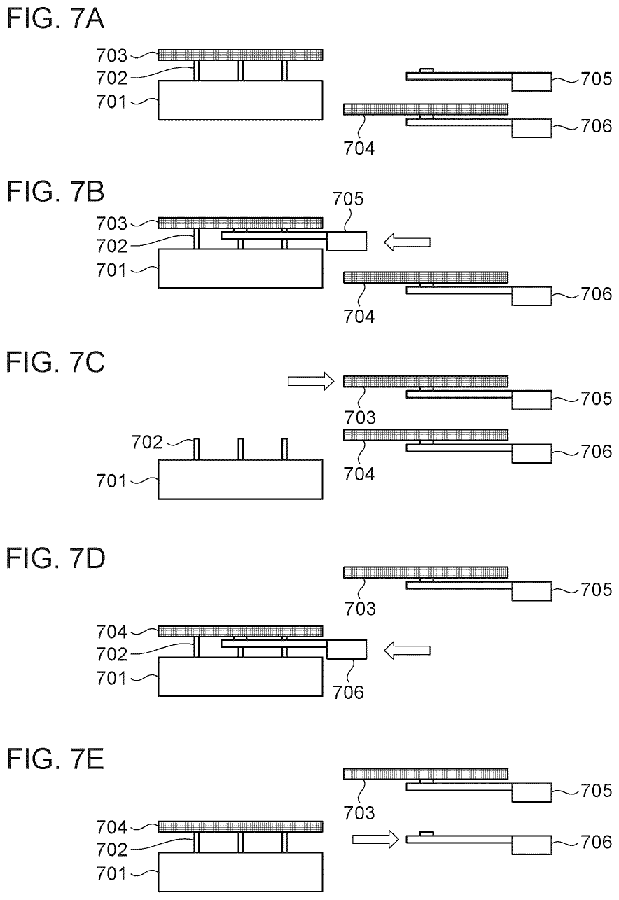

The details of the substrate swap operation will be described with reference to FIGS. 7A to 7E. FIGS. 7A to 7E are diagrams that show a sequence in which a first substrate 703 that has been subjected to a supply process at the supply section 109 is collected, and a second substrate 704 is placed, using two hands. The supply section 109 has a substrate chuck 701 and lift-up pins 702 that extend and retract relative to the chuck surface of the substrate chuck 701 through a lifting mechanism. The conveyor robot (second conveyor robot 104) has two hands 705, 706. The two hands 705, 706 are disposed one above the other in a height direction (Z direction).

The first substrate 703 that has been subjected to the supply process at the supply section 109 is lifted up by the lift-up pins 702 and separated from the substrate chuck 701. At this time, the hand 705 is not holding the substrate because the hand 705 is used to collect a substrate, and the hand 706 is holding the second substrate 704 because the hand 706 is used to place a substrate (FIG. 7A). The hand 705 enters below the first substrate 703 lifted up from the substrate chuck 701 (FIG. 7B). After that, the hand 705 holds and collects the first substrate 703 (FIG. 7C). Subsequently, the hand 706 holding the second substrate 704 enters above the substrate chuck 701 (FIG. 7D). Then, the hand 706 places the second substrate 704 on the lift-up pins 702, and then, the hand 706 retracts (FIG. 7E). The substrate swap operation is performed by this series of actions.

The vertical positions of the hands 705, 706 may be inverted. In the above example, the substrate swap operation in the supply section 109 by the second conveyor robot 104 has been described, and the substrate swap operation can similarly be performed in each of the first planarization apparatus 110, the second planarization apparatus 111, the third planarization apparatus 113, and the fourth planarization apparatus 112.

The superstrate SS used for planarization in the first planarization apparatus 110, the second planarization apparatus 111, the third planarization apparatus 113, and the fourth planarization apparatus 112 can be replaced each time the superstrate SS planarizes a certain number of substrates. This is because the surface of the superstrate SS in contact with a moldable material may be contaminated by the moldable material or the like and, as a result, defects can occur on the substrate surface during planarization. For the conveyance of the superstrate SS, the same first conveyor robot 102 and second conveyor robot 104 used to convey substrates can be used. The fact that each of the first to fourth conveyor robots has two hands for holding a substrate has been described, and in addition, may further have a hand for conveying a superstrate SS.

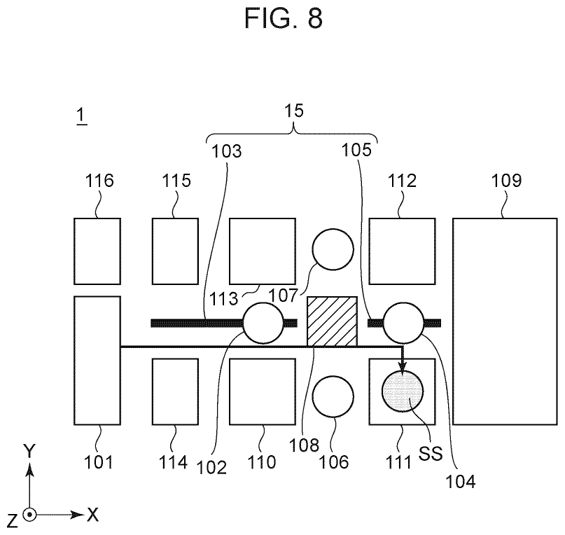

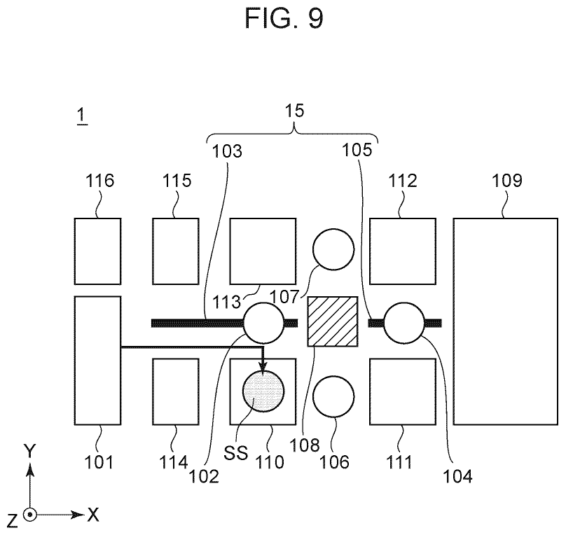

A process in which the superstrate SS is conveyed will be described with reference to FIGS. 8 and 9. FIG. 8 is a diagram that shows a process in which the superstrate SS is conveyed to the second planarization apparatus 111 via the placement section 108. The superstrate SS carried in from the carry-in section 101 is placed on the pre-alignment device 202 of the carry-in section 101. The superstrate SS pre-aligned by the pre-alignment device 202 is placed on the substrate placement portion 203 of the placement section 108 by the first conveyor robot 102. Subsequently, the second conveyor robot 104 receives the superstrate SS from the placement section 108 and conveys the superstrate SS to the second planarization apparatus 111. Another superstrate that is conveyed to the fourth planarization apparatus 112 can also be conveyed in a similar manner.

FIG. 9 is a diagram that shows a process in which the superstrate SS is conveyed to the first planarization apparatus 110 without passing through the placement section 108. The superstrate SS pre-aligned by the pre-alignment device 202 of the carry-in section 101 is conveyed to the first planarization apparatus 110 by the first conveyor robot 102. Another superstrate that is conveyed to the third planarization apparatus 113 can also be conveyed in a similar manner. In this way, when the destination to convey the superstrate SS is the first planarization apparatus 110 or the third planarization apparatus 113, the first conveyor robot 102 conveys the superstrate SS from the carry-in section 101 to the first planarization apparatus 110 or the third planarization apparatus 113 without passing through the placement section 108.

### Third Embodiment

In the second embodiment, a mode in which all the substrates in a lot are consecutively processed using the second method has been described.

In the present embodiment, a configuration for consecutively processing substrates in a system where multiple types of substrate processing are mixed within a lot will be described.

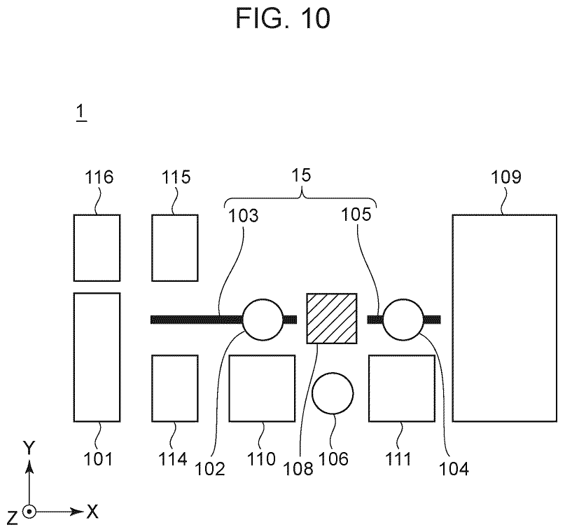

In the third embodiment, a case where the first and second substrates are processed using the second method (the same flow as in FIG. 10) and the third substrate is processed using the third method will be described.

In the present embodiment, conveyance is performed such that a subsequent substrate that is different in conveyance order or processing order interrupts and is conveyed before the next conveyance of the preceding substrate. In other words, before the second heat treatment of planarization for the second substrate, the third substrate is conveyed to the heat treatment apparatus and is subjected to heat treatment as an interrupt so that the heat treatment of the third substrate completes first. As a result, the time for which the third substrate waits in the apparatus is reduced, and the time saved can be used to process the next substrate, so further efficient substrate processing is possible as a whole.

In this way, when different processes are consecutively performed on a plurality of substrates as shown in FIG. 14, it is possible to perform an interrupt process in accordance with the end timing of the process.

### Fourth Embodiment

In the planarization system of the first embodiment, a heat treatment unit can be provided in the close adhesion layer forming apparatus and used as an additional second heat treatment apparatus. When the close adhesion layer forming apparatus and the heat treatment apparatus are configured as a common module, two or more modules, preferably, four or more modules, more preferably, eight or more modules, can be configured, and each capable of switching to perform different processes. Thus, an efficient process can be performed.

### Fifth Embodiment

A planarization system 1 according to the fifth embodiment will be described with reference to FIG. 10. In the first embodiment (FIG. 1), the planarization system 1 includes four planarization apparatuses; whereas, in the fifth embodiment (FIG. 10), the planarization system 1 includes two planarization apparatuses. In the present embodiment, the two planarization apparatuses are the first planarization apparatus 110 and the second planarization apparatus 111. In this case, the conveyance of a substrate between the placement section 108 and the first planarization apparatus 110 and between the placement section 108 and the second planarization apparatus 111 is performed by the third conveyor robot 106 as in the case of the first embodiment. In the present embodiment, since the planarization system 1 does not include the third planarization apparatus 113 or the fourth planarization apparatus 112, the planarization system 1 does not include the fourth conveyor robot 107.

The configuration of the carry-in section 101 and the configuration of the placement section 108 are similar to those of the first embodiment. Therefore, in this present embodiment as well, conveyance of a substrate between the carry-in section 101 and the placement section 108 is performed by the first conveyor robot 102, and conveyance of a substrate between the placement section 108 and the supply section 109 is performed by the second conveyor robot 104.

As described in the first embodiment, the number of substrates processed per hour by the supply section 109 is more than twice the number of substrates processed per hour by each of the plurality of planarization apparatuses. However, in the fifth embodiment, the numbers of substrates and superstrates carried in per unit time differ from those of the first embodiment. As described above, a processing time per substrate in the supply section 109 is shorter than or equal to ¼ of a processing time per substrate in each of the first planarization apparatus 110 and the second planarization apparatus 111. Therefore, when the number of substrates carried in per unit time is similar to that of the first embodiment, the number of substrates processed in each of the first planarization apparatus 110 and the second planarization apparatus 111 is less than the number of substrates processed in the supply section 109, so conveyance of substrates clogs. Therefore, in the fifth embodiment, the number of substrates carried in per unit time is halved compared to the first embodiment. By using the conveyance method described above, it is possible to consecutively process substrates.

### Embodiment of Article Manufacturing Method

Next, a manufacturing method for an article (such as a semiconductor IC element, a liquid crystal display element, a color filter, and a MEMS) using the above-described planarization system will be described. The manufacturing method includes a step of planarizing a composition placed on a substrate (such as a wafer and a glass substrate) by bringing the composition into contact with a superstrate, a step of curing the composition, and a step of separating the composition from the superstrate, using the above-described planarization system. Thus, a planarizing film is formed on the substrate. Then, a further working process, such as forming a pattern using a lithography apparatus, is performed on the substrate on which the planarizing film is formed, and the processed substrate is processed through other known working steps, with the result that an article is manufactured. The other known steps include patterning exposure and its associated front-end process, etching, resist removing, dicing, bonding, packaging, and the like.

According to this manufacturing method, it is possible to manufacture a higher quality article than before.

According to the present disclosure, it is possible to provide a technology that efficiently meets requirements of different flatnesses and that are advantageous for reducing processing time.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-181942, filed Oct. 17, 2024, which is hereby incorporated by reference herein in its entirety.

What is claimed is:

1. A planarization method using a planarization system including a plurality of processing apparatuses, wherein
the planarization system is configured to be able to perform, using the plurality of processing apparatuses, at least two steps of
forming a first planarizing film by bringing a superstrate into contact with a curable composition placed on a first substrate, and
spin coating a liquid film of a curable composition on a second substrate using a spin coat method, the planarization method comprising:
performing any one of the at least two steps to perform planarization of the first substrate or the second substrate.

2. The planarization method according to claim 1, comprising:
obtaining a first treated substrate by performing planarization, including the forming the first planarizing film, on the first substrate; and
obtaining a second treated substrate different in flatness from the first treated substrate by performing planarization, including the spin coating the liquid film, on the second substrate.

3. The planarization method according to claim 1, wherein one of the two steps is performed according to a requested substrate flatness, and planarization of a plurality of substrates is consecutively performed.

4. The planarization method according to claim 1, wherein, when planarization is consecutively performed on a plurality of substrates as a lot in the planarization system, planarization is consecutively performed on substrates including the first substrate on which the forming of the first planarizing film is performed and the second substrate on which the spin coating of the liquid film is performed.

5. A planarization method using a planarization system including a plurality of processing apparatuses, wherein
the planarization system is configured to be able to perform, using the plurality of processing apparatuses, at least two steps of
forming a first planarizing film by bringing a superstrate into contact with a curable composition placed on a first substrate, and
forming a second planarizing film by forming a liquid film obtained as a result of merging a plurality of liquid droplets of a curable composition placed on a second substrate and then curing the liquid film, the planarization method comprising:
performing any one of the at least two steps to perform planarization of the first substrate or the second substrate.

6. A planarization method using a planarization system including a plurality of processing apparatuses, wherein
the planarization system is configured to be able to perform, using the plurality of processing apparatuses, at least three steps of
forming a first planarizing film by bringing a superstrate into contact with a curable composition placed on a first substrate,
forming a second planarizing film by forming a liquid film obtained as a result of merging a plurality of liquid droplets of a curable composition placed on a second substrate and then curing the liquid film, and
spin coating a liquid film of a curable composition on a third substrate using a spin coat method, the planarization method comprising:
performing any one of the at least three steps to perform planarization of the first substrate, the second substrate, or the third substrate.

7. The planarization method according to claim 6, further comprising:
obtaining a first treated substrate by performing planarization, including the forming the first planarizing film, on the first substrate;
obtaining a second treated substrate different in flatness from the first treated substrate by performing planarization, including the spin coating the liquid film, on the third substrate; and
obtaining a third treated substrate different in flatness from the first treated substrate and the second treated substrate by performing planarization, including the forming the second planarizing film, on the second substrate.

8. The planarization method according to claim 6, wherein one of the three steps is performed according to a requested substrate flatness, and planarization of a plurality of substrates is consecutively performed.

9. The planarization method according to claim 6, wherein, when planarization is consecutively performed on a plurality of substrates as a lot in the planarization system, planarization is consecutively performed on substrates including at least two of the first substrate on which the forming of the first planarizing film is performed, the third substrate on which the spin coating of the liquid film is performed, and the second substrate on which the forming of the second planarizing film is performed.

10. The planarization method according to claim 6, wherein the planarization system is configured to be able to further perform
placing a plurality of liquid droplets of a curable composition on a fourth substrate, and
performing heat treatment for curing the curable composition placed on the fourth substrate, and the planarization system is configured to, as a basic process, perform a process selected from among
a first process in which a process is performed on a fifth substrate in order of the placing the plurality of liquid droplets, the forming the first planarizing film, and the performing heat treatment,
a second process in which a process is performed on a sixth substrate in order of the placing the plurality of liquid droplets, the forming the first planarizing film, the performing heat treatment, the placing the plurality of liquid droplets, and the forming the first planarizing film,
a third process in which a process is performed on a seventh substrate in order of the spin coating the liquid film and the performing heat treatment,
a fourth process in which a process is performed on an eighth substrate in order of the placing the plurality of liquid droplets and the forming the second planarizing film, and
a fifth process in which a process is performed on a ninth substrate in order of the placing the plurality of liquid droplets, the forming the first planarizing film, the performing heat treatment, and the spin coating the liquid film.

11. The planarization method according to claim 8, wherein, when the plurality of substrates is consecutively processed,
before a next step for a preceding substrate, a process is performed on a subsequent substrate with different processing order as an interrupt.

12. A planarization system that performs planarization of a first substrate or a second substrate, the planarization system comprising:
a conveyance mechanism configured to convey the first substrate or the second substrate;
a planarization apparatus configured to form a planarizing film by bringing a superstrate into contact with a curable composition placed on the first substrate; and
a spin coater configured to spin coat a liquid film of a curable composition on the second substrate using a spin coat method, wherein
the conveyance mechanism is configured to convey the first substrate or the second substrate to any one of the spin coater and the planarization apparatus, and the any one of the spin coater and the planarization apparatus is configured to perform a process on the first substrate or the second substrate.

13. The planarization system according to claim 12, further comprising:
a liquid droplet placement apparatus configured to place a plurality of liquid droplets of a curable composition on a third substrate; and
a heat treatment apparatus configured to perform heat treatment to cure the curable composition placed on the first substrate, the second substrate, or the third substrate, wherein
the conveyance mechanism is configured to sequentially convey the first substrate, the second substrate, or the third substrate to any one of the spin coater, the planarization apparatus, the liquid droplet placement apparatus, and the heat treatment apparatus, and the any one of the spin coater, the planarization apparatus, the liquid droplet placement apparatus, and the heat treatment apparatus is configured to perform a plurality of processes for the first substrate, the second substrate, or the third substrate.

14. A planarization system comprising:
a liquid droplet placement apparatus configured to place a plurality of liquid droplets of a curable composition on a first substrate; and
a planarization apparatus configured to form a planarizing film by bringing a superstrate into contact with the plurality of liquid droplets of the curable composition placed on the first substrate by the liquid droplet placement apparatus;
a spin coater configured to spin coat a liquid film of a curable composition on a second substrate using a spin coat method;
a heat treatment apparatus configured to perform heat treatment to cure the curable composition placed on the first substrate or the second substrate by the spin coater or the liquid droplet placement apparatus; and
a conveyance mechanism configured to convey the first substrate or the second substrate to the spin coater, the heat treatment apparatus, the liquid droplet placement apparatus, and the planarization apparatus, wherein
the conveyance mechanism is configured to convey the first substrate or the second substrate to any one of the spin coater, the heat treatment apparatus, the liquid droplet placement apparatus, and the planarization apparatus.

15. The planarization system according to claim 14, wherein an order in which the first substrate or the second substrate is conveyed to any one of the spin coater, the heat treatment apparatus, the liquid droplet placement apparatus, and the planarization apparatus is changed based on a requested substrate flatness.

16. The planarization system according to claim 15, wherein the conveyance mechanism is configured to convey the first substrate, the second substrate, a third substrate, a fourth substrate, or a fifth substrate in conveyance order selected from among at least two conveyance orders of
a first conveyance order in which the first substrate is conveyed in order of the liquid droplet placement apparatus, the planarization apparatus, and the heat treatment apparatus,
a second conveyance order in which a third substrate is conveyed in order of the liquid droplet placement apparatus, the planarization apparatus, the heat treatment apparatus, the liquid droplet placement apparatus, and the planarization apparatus,
a third conveyance order in which the second substrate is conveyed in order of the spin coater and the heat treatment apparatus,
a fourth conveyance order in which a fourth substrate is conveyed in order of the liquid droplet placement apparatus and the heat treatment apparatus, and
a fifth conveyance order in which a fifth substrate is conveyed in order of the liquid droplet placement apparatus, the planarization apparatus, the heat treatment apparatus, and the spin coater.

17. The planarization system according to claim 14, wherein a plurality of substrates is consecutively processed.

18. The planarization system according to claim 14, further comprising a control unit configured to control conveyance of the conveyance mechanism.

19. The planarization system according to claim 18, wherein the control unit is configured to perform conveyance such that, before next conveyance of a preceding substrate, a subsequent substrate with a different conveyance order is conveyed as an interrupt.

20. The planarization system according to claim 18, wherein the control unit is configured to control a substrate conveyance order by the conveyance mechanism and processing timing at the spin coater, the heat treatment apparatus, the liquid droplet placement apparatus, and the planarization apparatus.

21. The planarization system according to claim 14, further comprising a close adhesion layer forming apparatus configured to form a close adhesion layer on a sixth substrate, wherein
the sixth substrate on which a close adhesion layer is formed by the close adhesion layer forming apparatus is supplied to the liquid droplet placement apparatus or the spin coater.

22. The planarization system according to claim 21, wherein the close adhesion layer forming apparatus is configured to be switched and used as a second heat treatment apparatus.

23. A planarization system comprising:
a planarization apparatus configured to form a planarizing film by bringing a superstrate into contact with a curable composition placed on a first substrate;
a liquid droplet placement apparatus configured to place a plurality of liquid droplets on the first substrate;
a heat treatment apparatus configured to perform heat treatment to cure a liquid film formed as a result of merging the plurality of liquid droplets placed on the first substrate by the liquid droplet placement apparatus and then cure the liquid film and further perform heat treatment to further cure the planarizing film formed by the planarization apparatus; and
a conveyance mechanism configured to convey the first substrate to the liquid droplet placement apparatus, the heat treatment apparatus, the liquid droplet placement apparatus, the planarization apparatus, and the heat treatment apparatus, wherein
the planarization system is configured to change an order in which the first substrate is conveyed to any one of the heat treatment apparatus, the liquid droplet placement apparatus, and the planarization apparatus according to a requested substrate flatness.

24. The planarization system according to claim 22, wherein the conveyance mechanism is configured to convey the first substrate or a third substrate in conveyance order selected from among at least any two of
a first conveyance order in which the first substrate is conveyed in order of the liquid droplet placement apparatus, the planarization apparatus, and the heat treatment apparatus, and
a second conveyance order in which the third substrate is conveyed in order of the liquid droplet placement apparatus, the planarization apparatus, the heat treatment apparatus, the liquid droplet placement apparatus, and the planarization apparatus.

25. An article manufacturing method comprising: forming a planarizing film on a substrate using the planarization method according to claim 1; and performing further processing on the substrate on which the planarizing film is formed.

26. An article manufacturing method comprising: forming a planarizing film on a substrate using the planarization system according to claim 12; and performing further processing on the substrate on which the planarizing film is formed.
